(19) United States
(12) Patent Application Publication
(10) Pub. No.: US 2024/0127826 A1
(43) Pub. Date: Apr. 18, 2024

(54) VOICE-BASED AUTHENTICATION

(71) Applicant: CollegeNet, Inc., Portland, OR (US)

(72) Inventors: James H. Wolfston, West Linn, OR (US); Jeff M. Bolton, Portland, OR (US)

(21) Appl. No.: 18/046,441

(22) Filed: Oct. 13, 2022

(51) Int. Cl. G10L 17/24; G06F 21/32

(52) U.S. Cl. CPC G10L 17/24; G06F 21/32; G06F 2221/2113

(57) ABSTRACT

A voice-based authentication system receives uttered words from a user (e.g., a human speaker); compares the uttered words with an authentication text that includes high-confidence corpus words and one or more low-confidence corpus words from previous training or authentication; identifies high-confidence uttered words and at least one low-confidence uttered word based on the comparison with the authentication text; compares the high-confidence uttered words with a threshold; determines that the at least one low-confidence uttered word corresponds to any of the low-confidence corpus words of the authentication text; and grants access to a resource (e.g., a user account, a document, a building, or a vehicle) based on the comparison of the high-confidence uttered words with a threshold and on the determination that the at least one low-confidence uttered word corresponds to any of the one or more low-confidence corpus words.

### BACKGROUND

Automatic speech recognition (ASR) refers to processing of audio signals by computers for the purpose of recognizing speech. ASR includes basic processing such as automatic speech-to-text (STT) processing, in addition to more specialized processing, such as speaker verification. Speaker verification refers to the process of authenticating or verifying a speaker's claimed identity based on a voice signal.

In a typical speech verification scenario, a computer system verifies a speaker's identity by extracting speaker-specific characteristics from spoken words, phrases, or sentences in an audio signal and comparing those extracted characteristics with characteristics associated with the claimed identity. This may involve comparing input speech with a stored model or template and providing a result such as a similarity score or other metric. The computer system can then determine whether the identity of the speaker can be verified based on the similarity metric.

Speech verification is resource intensive and requires significant training for the system to be able to affirmatively identify an individual speaker among any number of possible speakers. Although speech verification can be useful in some scenarios, it is not typically desirable for verifying a user's identity for many common situations, such as authenticating a user that wishes to access a resource such as a user account, due to the level of training and resources required.

Yet other forms of authentication, including multi-factor authentication, do not take advantage of the benefits of voice-based technologies, which are more difficult for an impostor to imitate.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer-implemented method for authenticating a user (e.g., a live human speaker) comprises receiving voice input in the form of uttered words from a user in response to a challenge prompt; comparing the uttered words of the voice input with an authentication text (e.g., a pre-defined script or a randomly selected set of words from a corpus of words) that includes a plurality of high-confidence corpus words and one or more low-confidence corpus words from previous training or authentication; determining similarity scores for the individual uttered words based on the comparing; identifying a plurality of high-confidence uttered words and at least one low-confidence uttered word based on the similarity scores; comparing the high-confidence uttered words with a threshold; determining that the at least one low-confidence uttered word corresponds to any of the one or more low-confidence corpus words; and granting access to a resource (e.g., a user account, a document, a building, or a vehicle) based at least in part on the comparison of the high-confidence uttered words with a threshold and on the determination that the at least one low-confidence uttered word corresponds to any of the one or more low-confidence corpus words.

In some embodiments, the step of comparing the high-confidence uttered words with the threshold comprises comparing a percentage of the uttered words in the voice input identified as high-confidence with a corresponding percentage threshold or comparing the number of uttered words in the voice input identified as high-confidence with a corresponding number threshold.

In some embodiments, techniques described herein are performed as part of a multi-factor authentication process. For example, the method may be performed as a second step of a two-step authentication process that involves providing a password or PIN as a first step.

The uttered words may be spoken or sung. In some embodiments, the method further comprises analyzing a pitch, rhythm or speaking speed of the voice input, wherein granting access to the resource is further based on the pitch, rhythm, or speaking speed. For example, in addition to the comparison of the high-confidence uttered words with a threshold and the determination that the at least one low-confidence uttered word corresponds to any of the one or more low-confidence corpus words, the computer system may compare the pitch, rhythm or speaking speed of the voice input relative to pitch, rhythm, or speaking speed in speech by an authentic user in previous training or authentications.

In another aspect, a computer system receives voice input in the form of uttered words from a user; compares the uttered words of the voice input with an authentication text including a plurality of high-confidence corpus words and a plurality of low-confidence corpus words; identifies a plurality low-confidence uttered words based on the comparison of the uttered words with the authentication text; determines that the low-confidence uttered words correspond to the low-confidence corpus words of the authentication text; and grants access to a resource based at least in part on the determination that the low-confidence uttered words correspond to the low-confidence corpus words of the authentication text.

In another aspect, a computer-implemented method for staging and carrying out authentication of a user comprises presenting a user with a series of dictionary words; recording first uttered words from the user corresponding to the series of dictionary words; assigning a confidence score to each of the first uttered words based on a comparison of the first uttered words with standard pronunciations of corresponding words in the series, wherein at least some of the first uttered words have confidence scores in a lower range and are deemed to be low-confidence words; receiving voice input in the form of second uttered words in response to a challenge prompt including at least one of the low-confidence words; assigning an authentication score for each of the second uttered words based on a comparison of the second uttered words with the standard pronunciations of corresponding words in the challenge prompt; and granting access to a resource (e.g., to the authenticated user) based at least in part on a determination that at least one of the second uttered words has an authentication score within a predefined range of the confidence score of the at least one low-confidence word. The challenge prompt may include a pre-defined script or words randomly selected from the series of dictionary words. The granting of access to the resource may be performed as part of a multi-factor authentication process. The method may further include performing analysis of a pitch, rhythm or speaking speed of the voice input, and the granting of access to the resource may be further based on this analysis. The uttered words may be spoken or sung.

Illustrative computing devices and systems are also described.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computer system in which described embodiments may be implemented;

FIGS. 2A, 2B, and 2C are diagrams depicting presentation of a challenge prompt to a user via a user interface of a client application along with illustrative identifications of uttered words and corpus words as high-confidence or low-confidence words;

FIG. 3 is a flow chart of an illustrative process for voice-based authentication, in accordance with embodiments described herein; and

FIG. 4 is a flow chart of an illustrative process for voice-based authentication, in accordance with embodiments described herein; and

FIG. 5 is a block diagram that illustrates aspects of an illustrative computing device appropriate for use in accordance with embodiments of the present disclosure.

### DETAILED DESCRIPTION

Embodiments of the present disclosure are generally directed to techniques and tools for voice-based authentication of users. For example, one or more embodiments of a described voice-based authentication engine can be used to determine whether to grant access to a resource (e.g., a user account, a document, a building, or a vehicle) based at least in part on a comparison of uttered words with an authentication text, which includes comparing low-confidence uttered words with corresponding low-confidence corpus words. Described embodiments can be used in both single-factor and multiple-factor authentication scenarios, such as where a password or PIN is used as a first step of authentication, and voice-based authentication is used as a second step of authentication.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

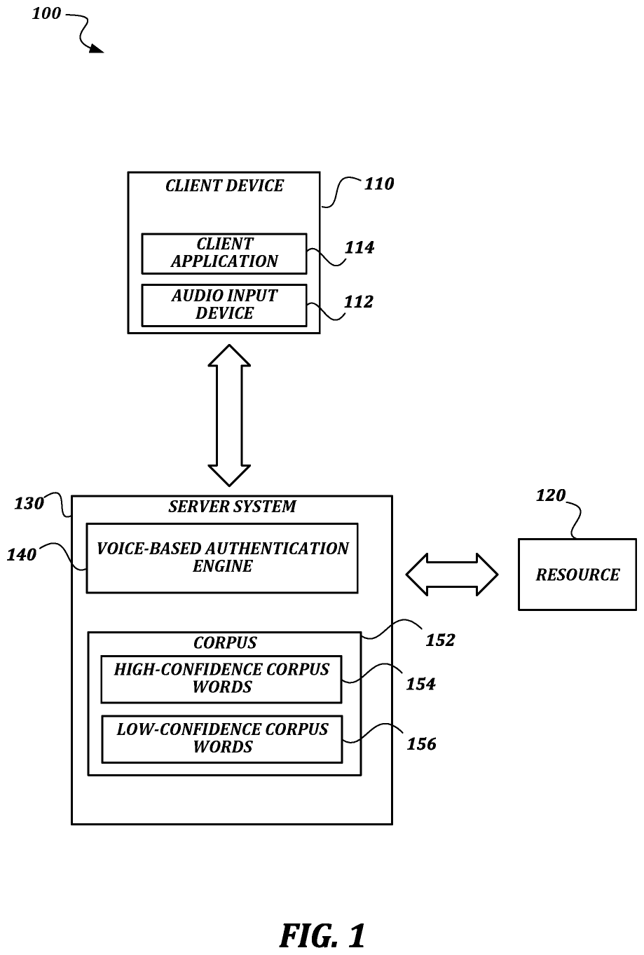

FIG. 1 is a schematic diagram of a computer system in which described embodiments may be implemented. In the example shown in FIG. 1, the computer system 100 includes a client device 110, a resource 120 and a server system 130 that provides access to the resource 120. The client device 110 includes a client application 114 and an audio input device 112 (e.g., an integrated or external microphone) that receives an audio signal from a user. The client device 110 converts the audio signal into a format that can be transmitted as voice input to the server system 130. The server system 130 receives the voice input from the client device 110 and processes the voice input in a voice-based authentication (VBA) engine 140, which determines whether to grant access to the resource 120 based on the received voice input. The server system 130 includes one or more computing devices of any suitable type which are programmed to perform functionality described herein. The client device 110 may be any suitable computing device programmed to perform functionality described herein, such as a smartphone, tablet computer, laptop or desktop computer, a smartwatch or other wearable computer, or a computing device integrated in another device, such as a vehicle computer system. The components of the computer system 100 may communicate with each other via a network, which may include one or more sub-networks. For example, the network may comprise a local area network (e.g., a Wi-Fi network) that provides access to a wide-area network such as the Internet.

Many alternatives to the arrangement depicted in FIG. 1 are possible. Although FIG. 1 illustrates various components as being provided by the client device 110 or the server system 130, in some embodiments, the arrangement or functionality of the components may be different. For example, in some embodiments, components illustrated as being implemented in the client device 110 and the server system 130 may be combined in a single device or system, which may help to improve performance or reduce latency. As another example, although a single client device 110, a single resource 120, and a single server system 130 are shown in FIG. 1 for ease of illustration, it should be understood that the system can be expanded to accommodate multiple client devices, multiple resources, and multiple server systems, as may be desired for a given implementation.

In some situations, the client device 110, the resource 120, and the server system 130 may all be separate devices or systems. In other situations, one or more of these devices may be integrated in the same device or system. For example, a user wishing to gain access to all functionality of a vehicle may interact with the vehicle as the client device 110 in a limited way by providing voice input to an audio input device 112 and a client application 114 integrated with the vehicle computer system. In this example, the resource 120 may be some other desired functionality of the vehicle (such as the ability to drive the vehicle). As another example, a user wishing to gain access to a building may interact with a building security system as the client device 110 by providing voice input to an audio input device 112 and a client application 114 integrated with the building security system. In this scenario, the resource 120 may provide physical access to the building, such as by automatically unlocking a door when user authentication is successful.

In the example shown in FIG. 1, the VBA engine 140 implements a speech recognition engine, which is used to analyze the voice input and compare the voice input with an expected input for authentication purposes. In some embodiments, the VBA engine 140 performs acoustic feature extraction on the voice input and uses one or more acoustic models and/or language models to in a decoding process to identify the uttered words. Once identified, the uttered words can be compared to the expected words in an authentication text, such as a predetermined paragraph, sentence, phrase, or other collection of words. In the example shown in FIG. 1, the VBA engine 140 compares uttered words with a corpus of words 152.

In some embodiments, the VBA engine 140 categorizes uttered words as high-confidence matching words or low-confidence matching words. For example, the VBA engine 140 may compare the uttered words with the corpus of words 152 and determine similarity or confidence scores for individual uttered words. High confidence words meet or exceed a threshold score (e.g., 90% confidence, 95% confidence, 99% confidence, or some other threshold). Low-confidence words fall below the threshold score. The particular scores, thresholds, or ranges of scores that may be used to define high-confidence or low-confidence words may vary depending on implementation. Although only two confidence classifications (low and high) are used in some examples for ease of illustration, it should be understood that additional confidence classifications also may be used, which may be associated with different thresholds or ranges of confidence scores. For example, in some situations it may be helpful to distinguish between high-confidence matching words, words that appear to match but at a lower level of confidence, and words that do not appear to match at all.

In some embodiments, the corpus of words 152 includes high-confidence corpus words 154 and low-confidence corpus words 156 from previous training or authentication instances. In such embodiments, the server system 130 may, in performing training or authentication, keep track of which uttered words tend to be low-confidence matches and which tend to be high-confidence matches. As these results are tracked, the corpus words themselves may be tagged or otherwise identified as high-confidence or low-confidence on this basis.

In some embodiments, the authentication text includes both high-confidence and low-confidence corpus words. In such embodiments, the authentication text includes words that may be expected to differ from a typical accurate pronunciation based on previous training or authentication instances, such as words that are consistently mispronounced or distinctively pronounced by an authentic user as part of authentication instances that are otherwise sufficiently accurate to result in a successful authentication. The inclusion of some low-confidence words in an authentication text, rather than only high-confidence words, may allow the system to avoid false-positives (i.e., erroneously identifying an impostor as authentic) in some situations, such as where the overall number of high-confidence uttered words meets a threshold, but the words identified as low-confidence (if any) are inconsistent with those deemed low-confidence in previous training or authentication instances.

Accordingly, in some embodiments, the VBA engine 140 compares high-confidence uttered words with a threshold (e.g., a threshold number of high-confidence words, or a threshold ratio or percentage of high-confidence words) and also determines whether any low-confidence uttered words correspond to low-confidence corpus words. In an illustrative scenario, where the VBA engine 140 determines that a threshold percentage of high-confidence uttered words has been achieved, the VBA engine 140 may nevertheless determine that access to the resource should be not granted if inconsistencies are identified between low-confidence uttered words and low-confidence corpus words. The inconsistencies on which this determination may be made can take different forms.

In an illustrative scenario, the VBA engine 140 may identify one or more low-confidence uttered words and search for matching low-confidence corpus words. If matching low-confidence corpus words are found for each of the one or more low-confidence uttered words, this portion of the authentication test passes. If matching low-confidence corpus words are not found for the low-confidence uttered words, such as where corresponding corpus words are tagged as high-confidence rather than low-confidence, this portion of the authentication test fails. At this point, the user may be given one or more opportunities to re-authenticate, or the process may end. The number of opportunities to re-authenticate after an unsuccessful attempt and/or the thresholds being used for different parts of the authentication process may vary depending on design considerations, security considerations, user preferences, detected environmental noise, or other factors.

In some embodiments, the voice input is responsive to a challenge prompt presented to the user. The challenge prompt may be presented to the user as audio, text, or video via the client application 114, or using some other visual, audio, or haptic technique, or in some other way. The challenge prompt may be associated with, but not actually recite, a particular authentication text such as a sentence, phrase, or other combination of words to be spoken by the user. For example, the challenge prompt may be a statement such as “Please speak your pass phrase to authenticate,” which the user will be expected to recite aloud. Alternatively, the challenge prompt may include the actual words to be recited. For example, the challenge prompt may be a statement such as, “Please repeat the following words,” followed by the words to be repeated. The words to be repeated may be provided as audio output to the user, or in displayed text, or a combination thereof. Alternatively, the challenge prompt may be omitted. In such a case, the user may simply begin speaking without being prompted to provide the voice input (e.g., after first speaking a wake word or other signifier to alert the system to process the voice input that follows).

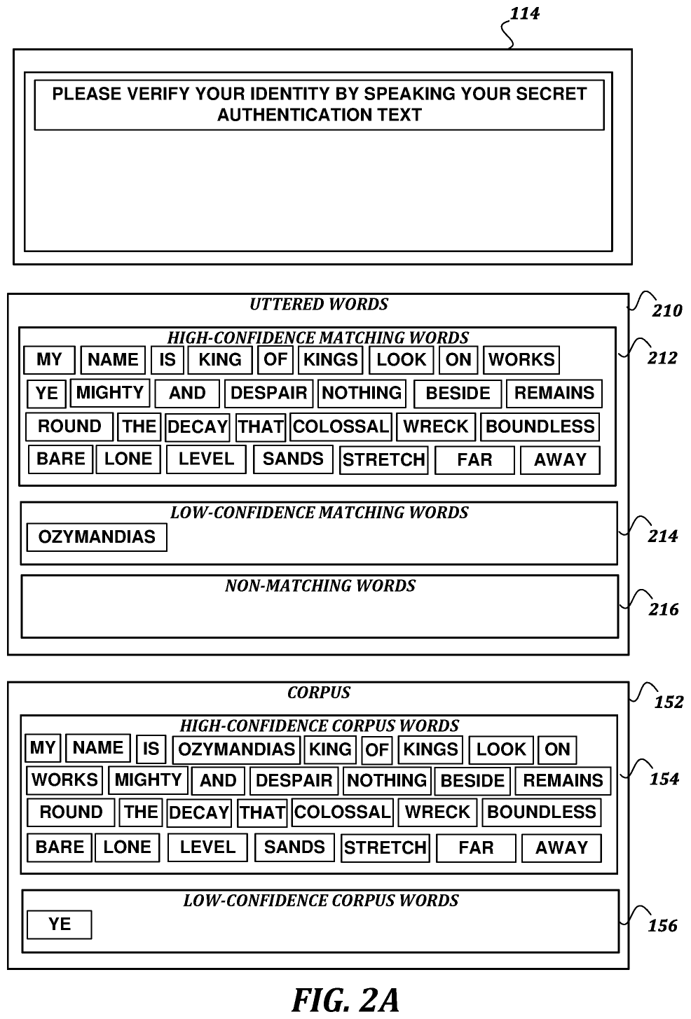

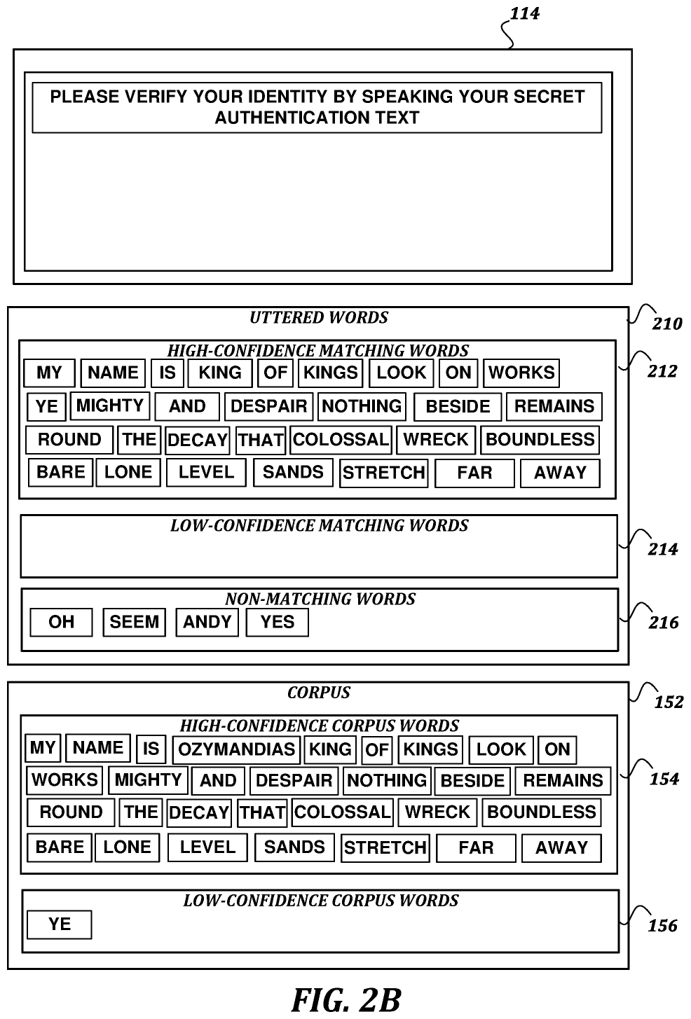

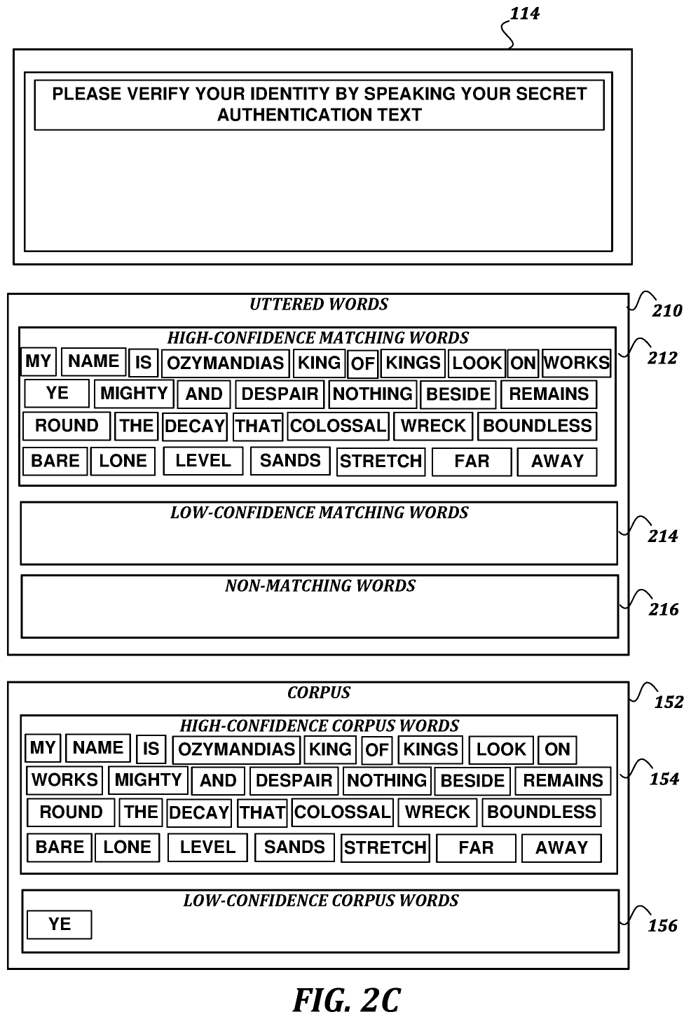

FIG. 2A is a diagram depicting presentation of a challenge prompt to a user via a user interface of a client application 114 along with an illustrative identification of uttered words as high-confidence or low-confidence words in comparison with corresponding corpus words. The VBA engine 140 receives voice input in response to the challenge prompt and compares uttered words 210 to the corpus of words 152, which includes the words from the authentication text. The corpus of words 152 includes high-confidence corpus words 154 and low-confidence corpus words 156. In this example, an impostor has obtained a copy of the secret authentication text and is attempting to gain access to the resource. The VBA engine 140 has found matching words in the authentication text for all of the uttered words 210 (thus the set of non-matching words 216 is empty). Alternatively, rather than separately tracking which words are matches but at a low confidence level, and which words do not appear to match at all, such words may be treated the same way, e.g., as low-confidence words.

In the example shown in FIG. 2A, all the uttered words are identified as high-confidence matching words 212 except for “Ozymandias,” which is identified as a low-confidence matching word 214. Thus, 30 of 31 uttered words (which in this case excludes repeated words) are identified as high-confidence matching words. Among the corpus of words 152, it is also true that 30 of 31 are identified as high-confidence words. Thus, in the illustrated example, the number and ratio of high-confidence words among the uttered words is the same. However, based on previous authentications, the VBA engine 140 has tagged “Ozymandias” as a high-confidence corpus word, whereas “ye” is tagged as a low-confidence word because the authentic user has consistently mispronounced the word “ye” during previous authentications. In some embodiments, corpus words may be identified as low-confidence where the words are either not recognized during successful authentication attempts, or recognized at a low level of confidence. The actual levels of confidence or confidence scores deemed low or high may vary based on system design considerations, user preferences, or other factors.

In an illustrative scenario corresponding to the example of FIG. 2A, the VBA engine 140 compares the high-confidence uttered words 212 with a threshold percentage of 95% high-confidence, matching words. Because 30 of 31 uttered words (96.8%) are deemed high-confidence, matching words, the threshold percentage is met, and the first portion of the authentication test passes. However, the low-confidence uttered word (“Ozymandias”) does not match the low-confidence corpus word (“ye”). Therefore, the second portion of the authentication test fails and, consequently, the authentication in general fails, even though the percentage of matching, high-confidence uttered words has been met.

Consider another scenario illustrated in FIG. 2B. Here, the impostor suspects that the pronunciation of “Ozymandias” was incorrect in the previous attempt, and so the impostor carefully and slowly speaks the word “Ozymandias,” which is normally a high-confidence word for the authentic user. The VBA engine 140 interprets the impostor's effort to pronounce “Ozymandias” slowly and carefully as being four separate words that do not match any words in the authentication text—these four words are deemed non-matching words 216. (Similarly, other characteristics of hesitant speech, including words or sounds such as “um,” “er,” or “uh,” may result in non-matching or low-confidence words.) Here, the first portion of the authentication test fails because only 30 of 34 uttered words (88.2%) are deemed high-confidence, matching words.

Finally, consider the scenario illustrated in FIG. 2C. Here, the impostor has researched the correct pronunciation of “Ozymandias” which, after a third attempt by the impostor, the VBA engine 140 has now identified as a high-confidence matching word, along with all the other uttered words. The first portion of the authentication test passes (100%). Still, the overall authentication fails because, unknown to the impostor, the authentic user has consistently mispronounced the word “ye” during previous authentications. Thus, the impostor has failed to gain access to the resource even after learning the secret authentication text and pronouncing all the words correctly. In this way, the authentic user's habit of consistently mispronouncing “ye” becomes an additional security feature, even for systems that have not been trained to affirmatively identify the authentic user's voice.

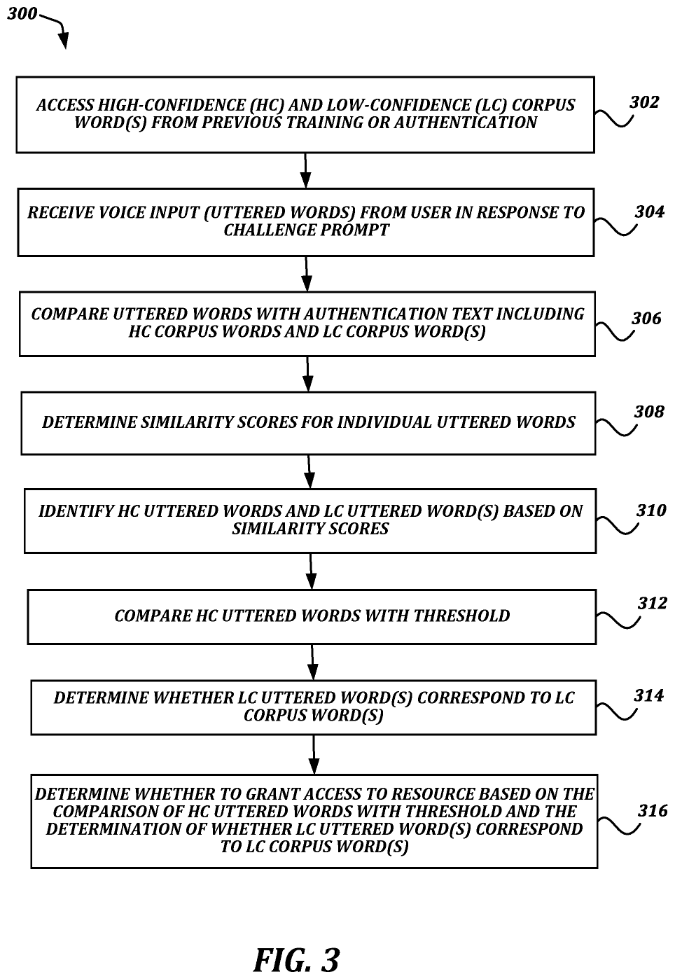

FIG. 3 is a flow chart of an illustrative process for voice-based authentication, in accordance with embodiments described herein. The process 300 may be performed by a computer system such as the server system 130 or one or more components thereof, or some other device or system.

At process block 302, the computer system accesses high-confidence and low-confidence corpus words from previous training or authentication. At process block 304, the computer system receives input in the form of uttered words from a user (e.g., a live human speaker) in response to a challenge prompt. The uttered words correspond to an authentication text to be recited by the user, which may be predefined or generated at the time of the authentication. In the case of a predefined authentication text, the user may be expected to recite the text from memory or by referring to a separate copy of the text. If the authentication text is generated at the time of the authentication (e.g., as a set of randomly selected words from the corpus), the authentication text to be recited may be displayed or otherwise presented to a user at the time of authentication.

At process block 306, the computer system compares the uttered words with the authentication text, which includes high-confidence corpus words and one or more low-confidence corpus words. At process block 308, the computer system determines similarity scores for the individual uttered words based on the comparison. At process block 310, the computer system identifies high-confidence uttered words and low-confidence uttered words based on the similarity scores. In some embodiments, high-confidence uttered words include uttered words for which a match is found in the authentication text at a high level of confidence, whereas low-confidence uttered words include uttered words for which a match is found in the authentication text, but at a lower level of confidence than the high-confidence uttered words. Low-confidence uttered words also may include words where no match is found.

At process block 312, the computer system compares the high-confidence uttered words with a threshold. For example, the computer system may compare the percentage of uttered words identified as high-confidence with a corresponding percentage threshold, or the number of uttered words in the voice input identified as high-confidence with a corresponding number threshold.

At process block 314, the computer system determines whether any low-confidence uttered words correspond to any of the low-confidence corpus words from the authentication text. Then, at process block 316, the computer system determines whether to grant access to a resource based on the comparison of the high-confidence uttered words with the threshold and on the determination of whether any low-confidence uttered words correspond to low-confidence corpus words. In an embodiment, if the computer system determines that the percentage of high-confidence uttered words exceeds a threshold percentage and that any low-confidence uttered words correspond to low-confidence corpus words in the authentication text, the computer system grants access to the resource. If the computer system determines that the percentage of high-confidence uttered words does not meet the threshold percentage or if a low-confidence uttered word does not correspond to any low-confidence corpus words in the authentication text, the computer system does not grant access to the resource.

Many alternatives to this illustrative process for voice-based authentication are possible. For example, a computer system may focus on analyzing low-confidence uttered words without regard to whether high-confidence uttered words meet a particular threshold. Consider a scenario where an authentication text includes a plurality of low-confidence corpus words. The computer system may identify a plurality of low-confidence uttered words based on the comparison of the uttered words with the authentication text; determine that the low-confidence uttered words correspond to the low-confidence corpus words of the authentication text; and grant access to a resource based at least in part on the determination that the low-confidence uttered words correspond to the low-confidence corpus words of the authentication text. In this way, the computer system can take advantage of situations where the ways in which words are mispronounced are more distinctive than the overall accuracy of a recited authentication text.

To make an authentication process more precise and less prone to false-positive authentication, the computer system may look for a particular confidence level or range for the low-confidence words. For example, if an authentication text includes low-confidence corpus words of 60%, 55%, 70%, 50%, and 65% confidence levels, respectively, the computer system may determine whether low-confidence uttered words correspond to low-confidence corpus words by determining whether confidence levels of the low-confidence uttered words match the confidence levels of the low-confidence corpus words (e.g., within 10%, 5%, 3%, or some other range). In this scenario, if all the uttered words are high-confidence (e.g., 95% confidence level), authentication is denied. However, if the low-confidence uttered words are all lower confidence (e.g., 35% confidence level or lower) than the expected range of the low-confidence corpus words, authentication will also be denied. This can help to reduce the chance of false-positive authentications in some scenarios, such as where uttered words are low confidence due to a noisy acoustic environment or the fact that the user is not speaking the correct authentication text, rather than the user's particular style of speaking.

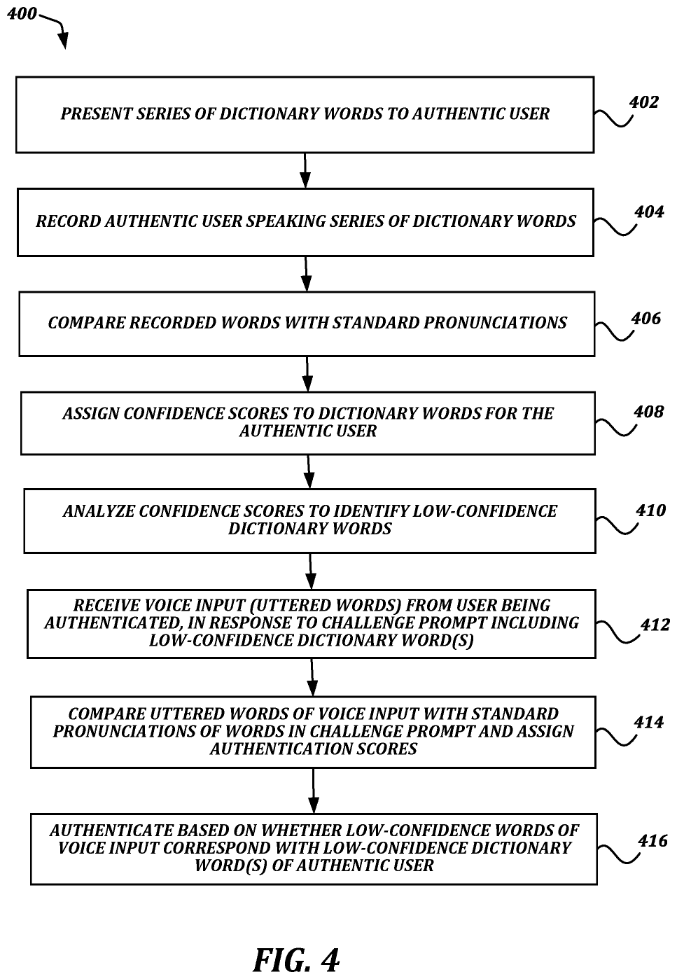

FIG. 4 is a flow chart of an illustrative process for staging and carrying out authentication of a user, with a particular focus on the distinctiveness of words that may be mispronounced by an authentic user in a distinctive way. The process 400 may be performed by a computer system such as the server system 130 or one or more components thereof, or some other device or system or combination of devices or systems.

At process block 402, in a staging or training phase, a computer system presents a series of dictionary words (e.g., via a visual or voice interface) to an authentic user. At process block 404, the system records the user speaking the series of dictionary words and, at process block 406, compares the recorded words with standard pronunciations (e.g., from a corpus of pre-recorded corresponding words spoken by other people). At process block 408, the system assigns a confidence score to each of those dictionary words for the authentic user based on those comparisons. At process block 410, the system analyzes those confidence scores to determine which of the dictionary words are low-confidence dictionary words for the authentic user. For example, the system may compare confidence scores of the dictionary words with a pre-defined threshold confidence score, and the dictionary words having confidence scores below the threshold may be deemed low-confidence dictionary words. Alternatively, the system may rank the dictionary words by confidence score and identify the words having the lowest confidence scores as low-confidence words.

The process of recording and scoring the spoken words can be performed once or multiple times in the staging phase. In some situations, it may be advantageous to score the spoken words multiple times in order to ensure that the authentic user is consistently mispronouncing the same words, thereby ensuring that the low-confidence words are a distinctive characteristic of the authentic user's speech rather than a temporary aberration.

In the authentication phase, an authentication system receives voice input from a user to be authenticated. The computer systems used in the staging and authentication phases may be the same computer system or different systems. For purposes of this example, the system used in the authentication phase is referred to as the authentication system.

At process block 412, the authentication system receives voice input in the form of uttered words from a user being authenticated in response to a challenge prompt that includes one or more of the low-confidence dictionary words for the authentic user. At process block 414, the authentication system compares the uttered words in the voice input with the standard pronunciations of the words in the challenge prompt and assigns confidence scores to each of those uttered words based on the comparisons, including the uttered words corresponding to the one or more low-confidence dictionary words for the authentic user. Such scores also can be referred to as “authentication scores” to distinguish them from the confidence scores obtained in the staging phase. At process block 416, the authentication system authenticates the user based on whether the low-confidence words of the voice input (based on authentication score(s)) correspond to the low-confidence dictionary word(s) for the authentic user. For example, the system may determine whether authentication scores for corresponding words in the voice input are within a predefined range of the corresponding confidence score(s) for the same words for the authentic user (e.g., within 10%, 5%, 3%, or some other range). If so, the authentication system authenticates the user. As another example, the authentication system may rank the words of the voice input by authentication score and determine whether the lowest-ranked words of the voice input correspond to the low-confidence dictionary words.

### Illustrative Computing Devices and Operating Environments

Unless otherwise specified in the context of specific examples, described techniques and tools may be implemented by any suitable computing device or set of devices.

In any of the described examples, an engine may be used to perform actions. An engine includes logic (e.g., in the form of computer program code) configured to cause one or more computing devices to perform actions described herein as being associated with the engine. For example, a computing device can be specifically programmed to perform the actions by having installed therein a tangible computer-readable medium having computer-executable instructions stored thereon that, when executed by one or more processors of the computing device, cause the computing device to perform the actions. The particular engines described herein are included for ease of discussion, but many alternatives are possible. For example, actions described herein as associated with a single engine may be performed by two or more engines on the same device or on multiple devices.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location. Alternatively, a peer-to-peer arrangement, or other models, can be used.

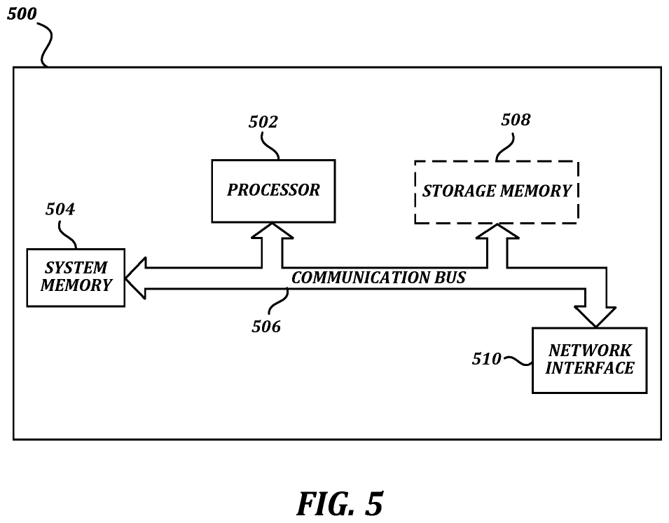

FIG. 5 is a block diagram that illustrates aspects of an illustrative computing device 500 appropriate for use in accordance with embodiments of the present disclosure. The description below is applicable to servers, personal computers, mobile phones, smart phones, tablet computers, smart speakers, smart watches, embedded computing devices, and other currently available or yet-to-be-developed devices that may be used in accordance with embodiments of the present disclosure.

In its most basic configuration, the computing device 500 includes at least one processor 502 and a system memory 504 connected by a communication bus 506. Depending on the exact configuration and type of device, the system memory 504 may be volatile or nonvolatile memory, such as read only memory (“ROM”), random access memory (“RAM”), EEPROM, flash memory, or other memory technology. Those of ordinary skill in the art and others will recognize that system memory 504 typically stores data and/or program modules that are immediately accessible to and/or currently being operated on by the processor 502. In this regard, the processor 502 may serve as a computational center of the computing device 500 by supporting the execution of instructions.

As further illustrated in FIG. 5, the computing device 500 may include a network interface 510 comprising one or more components for communicating with other devices over a network. Embodiments of the present disclosure may access basic services that utilize the network interface 510 to perform communications using common network protocols. The network interface 510 may also include a wireless network interface configured to communicate via one or more wireless communication protocols, such as WiFi, 2G, 3G, 4G, LTE, 5G, WiMAX, Bluetooth, and/or the like.

In FIG. 5, the computing device 500 also includes a storage medium 508. However, services may be accessed using a computing device that does not include means for persisting data to a local storage medium. Therefore, the storage medium 508 depicted in FIG. 5 is optional. In any event, the storage medium 508 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and nonremovable media implemented in any method or technology capable of storing information, such as computer-readable instructions, data structures, program modules, or other data. In this regard, the system memory 504 and storage medium 508 depicted in FIG. 5 are examples of computer-readable media.

For ease of illustration and because it is not important for an understanding of the claimed subject matter, FIG. 5 does not show some of the typical components of many computing devices. In this regard, the computing device 500 may include input devices, such as a keyboard, keypad, mouse, trackball, microphone, video camera, touchpad, touchscreen, electronic pen, stylus, and/or the like. Such input devices may be coupled to the computing device 500 by wired or wireless connections including RF, infrared, serial, parallel, Bluetooth, USB, or other suitable connection protocols using wireless or physical connections.

In any of the described examples, input data can be captured by input devices and processed, transmitted, or stored (e.g., for future processing). The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 500 (e.g., a client device), or can be integral components of the computing device 500. In some embodiments, multiple input devices may be combined into a single, multifunction input device (e.g., a video camera with an integrated microphone). The computing device 500 may also include output devices such as a display, speakers, printer, etc. The output devices may include video output devices such as a display or touchscreen. The output devices also may include audio output devices such as external speakers or earphones. The output devices can be separate from and communicatively coupled to the computing device 500, or can be integral components of the computing device 500. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft .NET™ languages such as C #, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### EXTENSIONS AND ALTERNATIVES

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or system may instead be performed by one or more other devices, modules, or systems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software may instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages.

Many alternatives to the user interfaces described herein are possible. In practice, the user interfaces described herein may be implemented as separate user interfaces or as different states of the same user interface, and the different states can be presented in response to different events, e.g., user input events. The user interfaces can be customized for different devices, input and output capabilities, and the like. For example, the user interfaces can be presented in different ways depending on display size, display orientation, whether the device is a mobile device, etc. The information and user interface elements shown in the user interfaces can be modified, supplemented, or replaced with other elements in various possible implementations. For example, various combinations of graphical user interface elements including text boxes, sliders, drop-down menus, radio buttons, soft buttons, etc., or any other user interface elements, including hardware elements such as buttons, switches, scroll wheels, microphones, cameras, etc., may be used to accept user input in various forms. As another example, the user interface elements that are used in a particular implementation or configuration may depend on whether a device has particular input and/or output capabilities (e.g., a touchscreen). Information and user interface elements can be presented in different spatial, logical, and temporal arrangements in various possible implementations. For example, information or user interface elements depicted as being presented simultaneously on a single page or tab may also be presented at different times, on different pages or tabs, etc. As another example, some information or user interface elements may be presented conditionally depending on previous input, user preferences, or the like.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method for staging and carrying out authentication of a user, the method comprising, by a computer system:
presenting a user with a series of dictionary words;
recording first uttered words from the user corresponding to the series of dictionary words;
assigning a confidence score to each of the first uttered words based on a comparison of the first uttered words with standard pronunciations of corresponding words in the series, wherein at least some of the first uttered words have confidence scores in a lower range and are deemed to be low-confidence words;
receiving voice input in the form of second uttered words in response to a challenge prompt including at least one of the low-confidence words;
assigning an authentication score for each of the second uttered words based on a comparison of the second uttered words with the standard pronunciations of corresponding words in the challenge prompt; and
granting access to a resource based at least in part on a determination that at least one of the second uttered words has an authentication score within a predefined range of the confidence score of the at least one low-confidence word.

2. The method of claim 1, wherein the challenge prompt comprises a pre-defined script.

3. The method of claim 1, wherein the challenge prompt includes words that are randomly selected from the series of dictionary words.

4. The method of claim 1, wherein the granting access to the resource is performed as part of a multi-factor authentication process.

5. The method of claim 1 further comprising performing analysis of a pitch, rhythm or speaking speed of the voice input, wherein granting access to the resource is further based on the analysis.

6. The method of claim 1, wherein the second uttered words are spoken.

7. The method of claim 1, wherein the second uttered words are sung.

8. The method of claim 1, wherein the resource comprises a user account, a document, a building, or a vehicle.

9. A non-transitory computer-readable medium having stored thereon computer-executable instructions configured to cause a computer system to authenticate a user by performing steps comprising:
presenting a user with a series of dictionary words;
recording first uttered words from the user corresponding to the series of dictionary words;
assigning a confidence score to each of the first uttered words based on a comparison of the first uttered words with standard pronunciations of corresponding words in the series, wherein at least some of the first uttered words have confidence scores in a lower range and are deemed to be low-confidence words;
receiving voice input in the form of second uttered words in response to a challenge prompt including at least one of the low-confidence words;
assigning an authentication score for each of the second uttered words based on a comparison of the second uttered words with standard pronunciations of corresponding words in the challenge prompt; and
granting access to a resource based at least in part on a determination that at least one of the second uttered words has an authentication score within a predefined range of the confidence score of the at least one low-confidence word.

10. A non-transitory computer-readable medium having stored thereon computer-executable instructions configured to cause a computer system to authenticate a user by performing steps comprising:
receiving voice input in the form of uttered words from a user;
comparing the uttered words of the voice input with an authentication text including a plurality of high-confidence corpus words and one or more low-confidence corpus words;
determining similarity scores for the individual uttered words based on the comparing;
identifying a plurality of high-confidence uttered words and at least one low-confidence uttered word based on the similarity scores;
comparing the high-confidence uttered words with a threshold;
determining that the at least one low-confidence uttered word corresponds to any of the one or more low-confidence corpus words; and
granting access to a resource based at least in part on a comparison of the high-confidence uttered words with a threshold and on the determination that the at least one low-confidence uttered word corresponds to any of the one or more low-confidence corpus words associated with the challenge prompt.

11. The non-transitory computer-readable medium of claim 10, wherein the uttered words are uttered in response to a challenge prompt.

12. The non-transitory computer-readable medium of claim 10, the steps further comprising generating the authentication text for presentation as part of a challenge prompt.

13. The non-transitory computer-readable medium of claim 10, wherein the step of comparing the high-confidence uttered words with the threshold comprises:
comparing a percentage of the uttered words in the voice input identified as high-confidence with a corresponding percentage threshold; or
comparing the number of uttered words in the voice input identified as high-confidence with a corresponding number threshold.

14. The non-transitory computer-readable medium of claim 10, wherein the authentication text is randomly selected from the corpus of words.

15. The non-transitory computer-readable medium of claim 10, wherein the steps are performed as part of a multi-factor authentication process.

16. The non-transitory computer-readable medium of claim 10, wherein the steps further comprise analyzing a pitch, rhythm or speaking speed of the voice input, and wherein granting access to the resource is further based on the pitch, rhythm, or speaking speed.

17. The non-transitory computer-readable medium of claim 10, wherein the uttered words are spoken.

18. The non-transitory computer-readable medium of claim 10, wherein the uttered words are sung.

19. The non-transitory computer-readable medium of claim 10, wherein the resource comprises a user account, a document, a building, or a vehicle.

20. A computer system comprising a memory and a processor, the computer system being programmed to perform steps comprising:
receiving voice input in the form of uttered words from a user;
comparing the uttered words of the voice input with an authentication text including a plurality of high-confidence corpus words and a plurality of low-confidence corpus words;
identifying a plurality low-confidence uttered words based on the comparison of the uttered words with the authentication text;
determining that the low-confidence uttered words correspond to the low-confidence corpus words of the authentication text; and
granting access to a resource based at least in part on the determination that the low-confidence uttered words correspond to the low-confidence corpus words of the authentication text.
